(19) United States
(12) Patent Application Publication
(10) Pub. No.: US 2026/0112106 A1
(43) Pub. Date: Apr. 23, 2026

(54) SYSTEM AND METHOD FOR TECHNICAL DATA PROTECTION USING NERF MODELS

(71) Applicant: Textron Innovations Inc., Providence, RI (US)

(72) Inventors: Jeffrey W. Holcomb, Fort Worth, TX (US); Kristen Doelling, Grapevine, TX (US)

(21) Appl. No.: 18/921,295

(22) Filed: Oct. 21, 2024

(51) Int. Cl. G06T 17/00; G06V 10/82

(52) U.S. Cl. CPC G06T 17/00; G06V 10/82

(57) ABSTRACT

A method for providing protection of technical data using a neural radiance field (NeRF) model includes providing a NeRF model, storing a representation of a three-dimensional (3D) model in the NeRF model, receiving a first instruction indicating a requested view of the 3D model, and generating, from the NeRF model and according to the requested view, two dimensional (2D) image data associated with the 3D model, wherein the 2D image data is generated with at least one portion of the 3D model in the requested view being obfuscated in the 2D image.

### TECHNICAL FIELD

The present invention relates generally to a system and method for securing technical data in three-dimensional models, and, in particular embodiments, to a system and method for storing representations of a three-dimensional model in a neural radiance field (NeRF) model.

### BACKGROUND

Frequently, the manufacture or sale of large-scale products involves customization or analysis of a product to ensure that a delivered product will fit customer needs. Many times, this includes delivery of a digital representation of a product so that relevant parties can view an accurate representation of the proposed product prior to manufacture or customization of the product. For large-scale products such as ground vehicles, aircraft, industrial machinery, and the like, it would be impractical to use a model or demonstration product for customer engagement and approval due to logistical concerns.

Many manufacturers will provide a digital representation of a proposed product, allowing the manufacturer to include proposed customizations such as paint, finish work, installation and other customizations. Additionally, the use of digital representations allow rapid customization and adjustment of the proposed products. Many times, the digital representation is a digital model, such as computer aided drafting (CAD) model, or other three-dimensional (3D) model. The use of a digital model permits a customer to see an accurate representation of the finished product, as the model provided to the customer may be the actual model used by a manufacturer to actually manufacture the product, or may be a model that is closely related to the finished product.

However, the use of highly detailed models for display to a customer, validation of customizations, marketing, demonstrations, and the like may result in data with a great deal of technical information being released outside of the manufacturer's control. For example, sending a production CAD model of a vehicle to a customer may result, whether intentionally or not, in unauthorized third parties having access to sensitive technical data. The highly accurate information in a CAD model could allow a third party to manufacture unauthorized replacement parts, copy designs with a high degree of accuracy, develop competing products, use the model for unauthorized sales or demonstrations, or other unauthorized uses. While a variety of methods for encrypting information during transport are known, there is a lack of protection or encryption of 3D data during presentation.

### SUMMARY

An embodiment system includes one or more processors and at least one non-transitory computer readable memory connected to the one or more processors and including computer program code. The at least one non-transitory computer readable memory and the computer program code are configured, with the one or more processors, to cause the system to at least provide a neural radiance field (NeRF) model, store a representation of a three-dimensional (3D) model in the NeRF model, receive a first instruction indicating a requested view of the 3D model, and generate, from the NeRF model and according to the requested view, two dimensional (2D) image data associated with the 3D model, where the 2D image data is generated with at least one portion of the 3D model in the requested view being obfuscated in the 2D image.

An embodiment method includes providing a neural radiance field (NeRF) model, storing a representation of a three-dimensional (3D) model in the NeRF model, receiving a first instruction indicating a requested view of the 3D model, and generating, from the NeRF model and according to the requested view, two dimensional (2D) image data associated with the 3D model, wherein the 2D image data is generated with at least one portion of the 3D model in the requested view being obfuscated in the 2D image.

An embodiment method includes providing an AI agent comprising a neural network configured to store a neural radiance field (NeRF) model, and training the AI agent to store a representation of a three-dimensional (3D) model in the NeRF model, where at least one portion of the 3D model being obfuscated in the NeRF model, where the AI agent is configured to, after the training, generate, from the NeRF model and according to a first instruction indicating a requested view of the 3D model, two dimensional (2D) image data associated with the 3D model, wherein the 2D image data is generated with at least one portion of the 3D model in the requested view being obfuscated in the 2D image.

### BRIEF DESCRIPTION OF THE DRAWINGS

For a more complete understanding of the present invention, and the advantages thereof, reference is now made to the following descriptions taken in conjunction with the accompanying drawings, in which:

FIGS. 1A-1B are symbolic diagrams illustrating architectures for artificial intelligence (AI) agents with a NeRF model according to some embodiments;

FIG. 2 is a system diagram illustrating a system for training an AI agent to generate a trained model according to some embodiments;

FIG. 3A is a symbolic diagram illustrating an arrangement relating training to output data from a NeRF model according to some embodiments;

FIG. 3B is a symbolic diagram illustrating a system for using an AI agent with a NeRF model according to some embodiments; and

FIG. 4 is a flow diagram illustrating a method for training and using an AI agent with a NeRF model according to some embodiments.

### DETAILED DESCRIPTION OF ILLUSTRATIVE EMBODIMENTS

Representative embodiments of systems and methods of the present disclosure are described below. In the interest of clarity, features of an actual implementation may not be described in this specification. It will of course be appreciated that in the development of any such actual embodiment, numerous implementation-specific decisions may be made to achieve the developer's specific goals, such as compliance with system-related and business-related constraints, which will vary from one implementation to another. Moreover, it should be appreciated that such a development effort might be complex and time-consuming but would nevertheless be a routine undertaking for those of ordinary skill in the art having the benefit of this disclosure.

The increasing use of technology for the design and manufacture of aircraft, drones, ground vehicles, industrial machinery, electronics, circuits, and the like, has increasingly relied on highly accurate digital models for design, prototyping, production and sales of products. In order to avoid releasing technical details of products, a system that uses artificial intelligence (AI) to separate the technical model data from image data displayed to a customer or other user.

The principles presented herein relate to a system for transforming a digital model into a neural radiance field (NeRF) model using an artificial intelligence (AI). The AI may generate the NeRF model using two-dimensional (2D) images or a 3D model, and may store that describing the model using a structure that omits, obscures, or otherwise hides the fine technical detail of the product being modelled. Thus, an AI NeRF model may be used to encode a CAD model within the internals of a neural network while obscuring at least a portion of the 3D model. Various types of structures of NeRFs have been identified, with different NeRF types having different features, such as including a fully convolutional architecture that can condition on single image inputs (PixelNeRF) , using a geometric clustering algorithm and sparse network structure that enable it to process images with diverse lighting conditions (Mega-NeRD), Neural Sparse Voxel Fields (NSVF) that can skip any empty pixels during its rendering phase, which increases rendering speed, or other optimize NeRF structures. However, any type of NeRF can be used with the disclosed system, structure and method. The type of NeRF or optimization can be selected according the specific task or model for which the NeRF or AI model is intended.

The NeRF model allows inference of information of the model using data from multiple views of the model. A commonly used AI model for NeRF modeling system is a multilayer perceptron (MLP). The MLP is trained to map spatial coordinates and viewing directions to color and density values. An MLP uses a series of mathematical structures that organize inputs, such as a position in 3D space or a 2D viewing direction, to determine the color and density values at each point in a 3D image. The MLP uses inference of data, such as surfaces, faces, edges, vertices, and the like, to store a NeRF model that is an estimate or representation of a 3D model, but is likely to be less accurate or correct than the actual or target model. The MLP is also able to alter the brightness and color of light rays in the scene, and using radiance modeling, can display the NeRF model with different colors and densities from different perspectives.

Additionally, one or more target regions in training images may be occluded or removed from the training data prior to force the MLP to generate, within the NeRF model during training, inferred features to bridge, fill, or cover the occluded areas. This provides a higher level of security or detail elimination than relying solely on the interpretation by the training of the NeRF model.

Notably, the representation of the 3D model in the NeRF model includes the obscuring or omission of the technical data of the true 3D model, so that the technical detail of the 3D model is never stored in the NeRF model, permitting the NeRF model to be distributed without the risk that technical data will be subject to being accessed by unauthorized parties. This is because the system enables the compression and encryption of 3D CAD information to enable rapid and secure dissemination of engineering specifications.

The AI may generate images for display to a user based on a query to the AI for individual images or frames of a video. Thus, the NeRF model or AI with the NeRF model may be released outside of the manufacturer's control, but the precise technical detail on the model, such as measurements and the like may be omitted from the data released. This is because the NeRF model stores the data on the product as a continuous volumetric scene function, and outputs data as a set of densities and colors.

Training of an AI with a NeRF model results in a trained neural network that stores the model as a density representation of density of color found at each space or location of the model. Each voxel in a model may be represented by a neuron within the fully connected network forming the MLP, and training of neuronal networks to have a NeRF model may include training of neuronal weights for the densities of color at different points in space. The output of the NeRF model is a view of the model that cuts a slice of a volumetric region go get a density gradient as an output view. Thus, the NeRF model avoids storing data as a point cloud, as lines, edges, or the like.

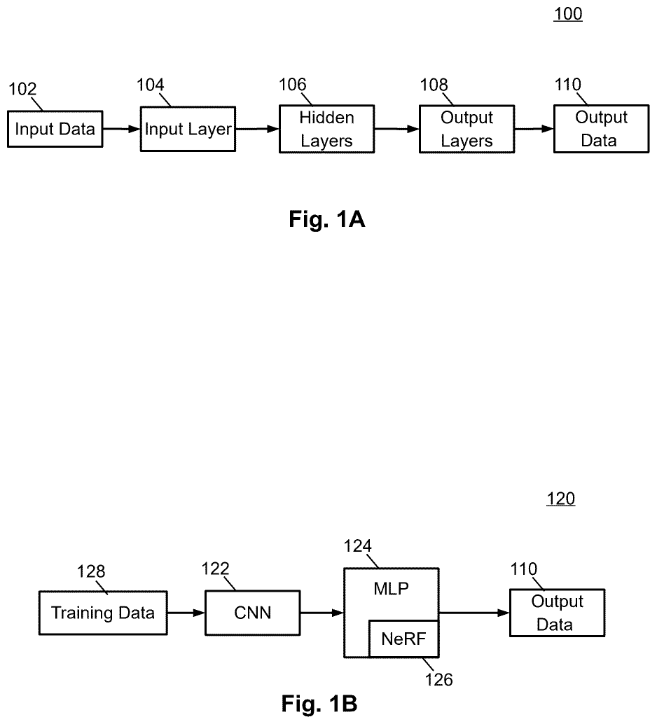

FIGS. 1A-1B are symbolic diagrams illustrating architectures for AI agents with a NeRF model according to some embodiments. AI models are a set of mathematical functions that can be used to correlate incoming data with known elements, such as views of 3D models. Thus, an AI model may be a set of functions used for storage of 3D model data in a NeRF model and for image or motion generation, or other AI processes. A commonly used AI model for a NeRF modeling system is the MLP, which may be used with a convolutional neural network (CNN) encoder. AI agents may be software or other implementations of an AI model, and may include functionality for storing data describing 3D models or scenes in a NeRF model.

FIG. 1A is a symbolic diagram illustrating layers of an AI model 100 according to some embodiments. An AI model 100 take in input data 102 though an input layer 104. In some embodiments, the input layer 104 converts input data 102 into a format usable by hidden layers 106. In some embodiments, the hidden layers 106 may be a set of filters, neurons, or other logical structures that store data in a NeRF to form a NeRF model that represents, emulates, describes, or is otherwise associated with, a 3D model.

For example, a NeRF model in the hidden layers 106 may be trained to output 2D images of a 3D model. The input data 102 may be, for example, a request for a 2D image representing the stored 3D model. The input data 102 may be a set of parameters describing a desired view of the 3D model represented by the NeRF model. In some embodiments, the input layer 104 may filter or the input data 102 into a format that improves the operation of the NeRF model and the resulting outputs. In some embodiments, the inputs may be transformed from a dimensional input such as spatial location and viewing direction coordinates into positional embedding in a higher dimension, which permits the NeRF model to better model high frequency features, such as features that repeat, have a relatively large change, or that change quickly within the model. In other embodiments, the input layer 104 may convert multidimensional input data 102 into a single dimension array, apply filters, trim or normalize input data 102, or perform other pre-processing functions.

An output layer 108 may be used to generate output data 110 based on data received from the hidden layers 106. In some embodiments, the output layer 108 uses the output from the hidden layers 106 to generate a 2D image that represents the product or features modelled in the NeRF model in the hidden layers 106 viewed from the location and camera angle identified by the input data 102. Thus, a NeRF model may generate data that is, or is transformed into, frames or images for display to a user as still perspective based model meshes, images, video, augmented reality (A/R) data, virtual reality (VR) data, or the like.

FIG. 1B is a symbolic diagram illustrating an arrangement of layers of a NeRF AI system 120 according to some embodiments. In some embodiments, a NeRF AI system 120 may include use of a CNN 122 with one or more convolution layers, and the CNN 122 may provide data to the MLP 124 for use in the NeRF model 126 of the MLP 124. The CNN 122 may provide one or more convolutions or filters to identify features in training data 128. For example, the CNN 122 may be an encoder that encodes an input image of the training data 128 into a pixel aligned feature grid that provides color and opacity data for inclusion in the NeRF model 126. In some embodiments, the MLP 124 is a feed forward, fully connected network, with the connections and data in each node of the MLP defining the NeRF 126 and the NeRF 126 storing a NeRF model representing a 3D model.

In some embodiments, training data may be processed using multiresolution hash encoding (MHE). Instead of training only the network parameters, encoding parameters or feature vectors are encoded. These feature vectors are arranged into different resolution levels and stored at the vertices of a grid. Each grid corresponds to a different resolution. For example, when using a 2D image to generate the NeRF model, at a specific location on the 2D image, surrounding grids for a location are located and indices to the vertices of the grids by hashing their coordinates. Each resolution grid has a corresponding predefined hash table that may be used to look up the corresponding trainable feature vectors. Hashing the vertices will give the indices in the corresponding look-up tables. The feature vectors of different resolutions are linearly interpolated to combine the feature vectors, and then concatenated alongside other auxiliary inputs to produce the final vector. The resulting feature vector is passed into the neural network for integration into the NeRF model of the fully connected layers 208.

Training the encodings or the NeRF model may include using the loss gradients propagated through the MLP, concatenation, and linear interpolation, and then accumulated in the looked-up feature vectors. The MHE process permits training of the encoding parameters alongside training of the network, resulting in boost in the quality of the final resulting NeRF model. Additionally, multiple resolutions, provides for increased level of detail, with the network learning both coarse and fine features.

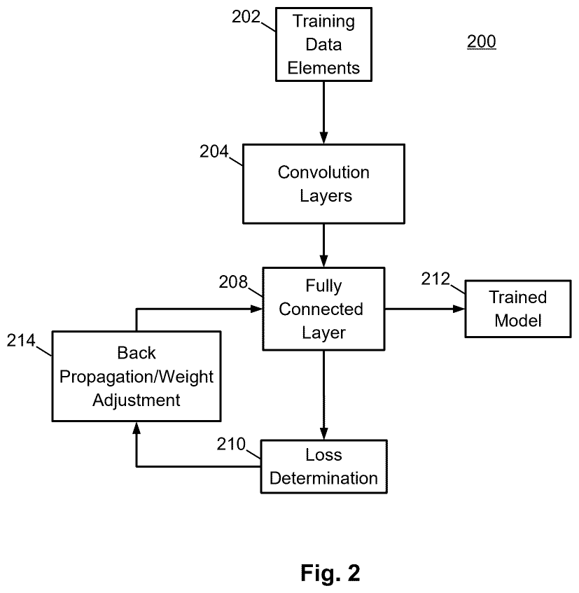

FIG. 2 is a system diagram illustrating a system 200 for training an AI to generate a trained model 212 according to some embodiments. A NeRF model uses training data elements 202 for training. After training using a set of weights and biases used to make predictions of the surfaces the 3D model, and after the error for those predictions is calculated as feedback, the training results in the trained AI model 212. Training the MLP 124 may include, in some embodiments, sending the training data 128 through MLP 124 so that the MLP 124 applies weights and biases to a variety of filters to identify surfaces, or other desired features from the input data. Additionally, in some embodiments, the MLP 124 may be at least partially pretrained before being trained on a particular model. In some embodiments, an MLP 124 may be selected for specific model training based on the accuracy of an output or training for a particular type of model. Different MPLs may be selected according to a type of the target structure, physical characteristics of the target structure, or other target structure characteristics. For example, different pre-trained MLPs may be selected for vehicles, for electronic devices or circuits, for mechanical devices, for target structures with high or low frequency elements or based on the sizes, types or numbers of details on the target structure, or the like. The pre-training may include, for example, training on generating accurate NeRF model representations of 3D models from 2D training images, generating accurate output images based on the NeRF model,

In some embodiments, a training data set having one or more training data elements 202 is identified. A training data set may include training data elements 202 with one or more digital representations of a target model, target scene, or anther digital representation of a 3D structure. In some embodiments, the digital representations are 2D images, 3D models, or the like. For example, the training data elements 202 may be static images, videos, models, drawings, or the like, and may have data that is missing or removed as part of the training process. The digital representations are of, or associated with, the target model or target scene that will be stored in the NeRF model.

The training data elements 202 may be preprocessed by an input layer (not shown) to prepare the training data elements 202 for filtering through one or more hidden layers such as convolution layers and pooling layers 204. The convolution layers 204 may have filters with adjustable weights or biases that affect the weight given to the respective filter when processing data. The training data elements 202 may be processed through the convolution and pooling layers 204 and the resulting data is output to one or more fully connected layers 208.

The fully connected layers 208 provide layers that store data or a NeRF model that represents, describes, or is otherwise associated with the 3D model.

In some embodiments, the fully connected layers 208 generate probabilities that each data element belongs to a particular classification.

In some embodiments, fully connected layers are feed forward neural networks. The fully connected layers 208 are densely connected, meaning that every neuron in the output is connected to every input neuron. In fully connected layers 208, every output neuron of a layer is connected to every input neuron of another layer through a different weight. This is in contrast to a convolution layer where the neurons are not densely connected but are connected only to neighboring neurons within a width of a convolutional kernel or filter. However, in a convolutional layer, the weights are shared among different neurons, which enables convolutional layers to be used with a large number of neurons.

The input to the fully connected layers 208 is the output from the final convolution or pooling layer 204, which is flattened and then fed into the fully connected layers 208. During training of an AI agent, outputs from the fully connected layers 208 are passed to a loss determination element 210 that evaluates the results of the AI agent processing and provides data used to adjust weights and biases of the convolutional layers by back propagation or weight adjustment 214. In some embodiments, the output during training may be compared to the training data itself to determine whether the output accurately reflects the training data. In other embodiments, verification data may be generated from, or otherwise associated with, the training data elements 202, and may be used for determining, by the loss determination element 210, the accuracy or loss from the output resulting from training the fully connected layers 208. The output images may be compared with the ground truth images for formulating a rendering loss that can be used to optimize the network or fully connected layers 208 by back propagation or weight adjustment. In some embodiments, a standard L2 loss can be computed using the input image/pixel in an autoencoder fashion.

For example, 2D images may be generated from a 3D target model, with the 2D images being provided to the convolution layers 204 and the fully connected layers 208 for training. Once one or more training data elements 202 are used to train the fully connected layers 208, and the fully connected layers 208 may provide one or more output images. The output images may be compared to training data elements 202, new 2D images generated from the 3D target model, or the like. Thus, training data elements 202 with first perspectives or view angles of the 3D target model may be used for training, and the testing of the training may include testing the output of the fully connected layers 208 ability to generate second output images at new, different views or view angles. The new, second output images generated for testing the training may be compared to views or verification images generated directly from, or according to, the 3D target mode, and the loss or accuracy determined by the loss determination element 210, which then uses back propagation or weight adjustment 214 to modify the weights, connections, or the like, within the fully connected layers 208. The loss determination element 210 specifies how training penalizes the deviation between the predicted output of the network, and the true or correct output image generation.

Various loss functions can be used, depending on the specific task. In some embodiments, the loss determination element 210 applies a loss function that estimates the error of a set of weights in the fully connected layers 208. For example, errors in an output may be measured for an output image at a particular view generated from a NeRF model by comparing the output image to a ground reference image, or an image that is expected to be generated at the selected view. The comparison may be on a pixel-by-pixel basis, a region-by-region basis, using an average error or mean square (L2) error calculation, or the like. The loss layer may use a loss analysis to determine loss for a training data element 202 or set of training data elements 202.

Back propagation allows application of the total loss determined by the loss determination element 210 back into the neural network to indicate how much of the loss every node is responsible for, and subsequent updating of the weights in a way that minimizes the loss by giving the nodes with higher error rates lower weights, and vice versa. For example, in some embodiments, a loss gradient may be calculated, and used, via back propagation or weight adjustment 214, for adjustment of the weights and biases in the convolution layers. A gradient descent algorithm may be used to change the weights so that the next evaluation of a training data element 202 reduces the error identified by the loss determination element 210, and where the optimization algorithm navigates down the gradient (or slope) of error. Once the training data element 202 are exhausted, or the loss of the NeRF model 126 falls below a particular threshold, the AI agent may be saved, and used as a trained model 212.

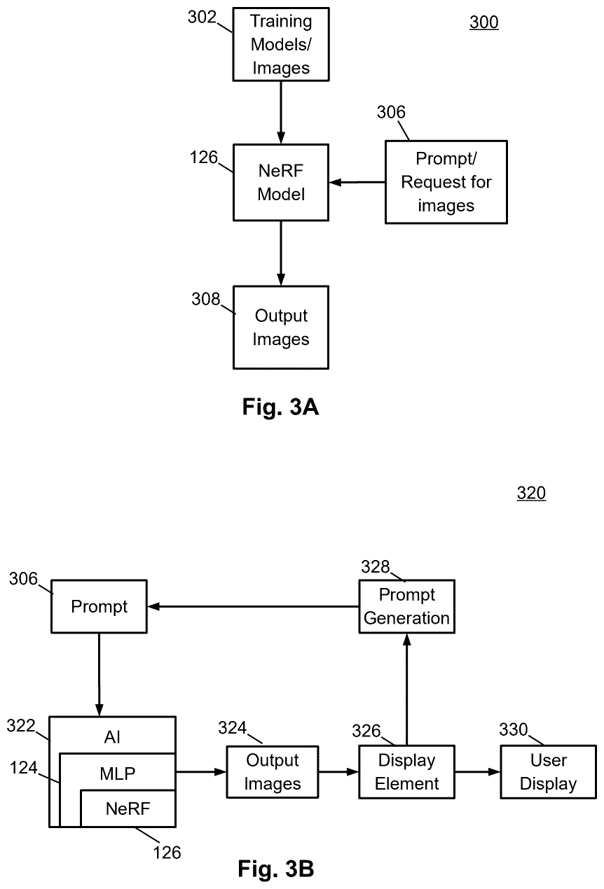

FIG. 3A is a symbolic diagram illustrating an arrangement 300 relating training to output data from a NeRF model 126 according to some embodiments. A system for training an AI and producing a trained AI model or AI agent with a NeRF model may, in some embodiments, be a machine or AI teaching and learning environment that provides for development of AI agents and related software, and for providing automated training, evaluation and testing of AI agents and related software. Training models or images 302 are provides as training data to a NeRF model, MPL, AI agent, or the like, and the training teaches the AI to generate a NeRF model that represents a target 3D model references by the training models or images.

In some embodiments, training of a NeRF model 126 includes sampling coordinates from original, input images such as training models or images 302. The training system emits rays at each pixel and sample at different timesteps, a process known as ray marching. Each sample point has a spatial location, a color, and a volume density. Calculations are the inputs of the neural field, and the NeRF model data related to the results of the ray matching. When training with training models or images, the system may generate image prompts 306 or requests for images and compare the resulting output images to the training modes or images to determine the accuracy of the NeRF model, with the accuracy used as the basis for feedback to the NeRF model.

In some embodiments, an image prompt 306 or a request for an image is a request or instructions to the NeRF model to generate an output image 308 showing the 3D model represented by the NeRF model from a particular perspective. A neural field or NeRF may advantageously output different representations for the same point when viewed from different angles, permitting generation of output images 308 from multiple angles, while using 2D images as training input. As a result, a NeRF model can capture various lighting effects such as reflections, and transparencies, making it ideal to render different views of the same scene, making a NeRF a better representation or a scene or model compared to voxels grid or meshes.

The image prompt 306 or image request may be generated by a training system or during training to generate an expected image for feedback during training. Alternative, once the AI system is trained, and an acceptable NeRF model is developed, the image prompt or image request may be an instruction requesting generation of image data associated with the 3D model. The instruction may be generated by a display system, an automated system, a user, a user interface, or the like, and may indicate a requested view of the 3D model. For example, a display system showing output images 308 to a user may receive a command from the user to rotate a view, and may generate an instruction requesting an image from a position that reflects the user command and that is relative to the model. In another embodiment, a video generation system may have a predetermined script for a video having multiple frames with images of the 3D model and may send requests to generate the desired frames for inclusion in the video.

In some embodiments, a NeRF accepts a 5D coordinate as input, with the 5D coordinate which consists of a spatial location (x, y, z) and viewing direction (θ, φ), where x, y, and z are coordinates in the NeRF model coordinate system and theta (θ) and phi (φ) are angles from planes in the NeRF model coordinate system. In some embodiments, the instruction requesting generation of image data associated with the 3D model, may include the 5D coordinates, and may, in some embodiments, include additional data or parameters, such as lighting parameters, environmental parameters, viewing frustum, or other instructions or parameters related to image generation. The particular point of the object or scene is fed into an MLP housing the NeRF model 126, which outputs the corresponding color intensities, using for example, and red-green-blue (RGB) system, along with a volume density □.

The NeRF model 126 may, in some embodiments store the data related to the 3D model in the Nerf Model as a probability or volume density indicating how much radiance or luminance is accumulated by a ray passing through the spatial location (x, y, z) and is a measure of the effect the point at the spatial location has on the overall scene. The probability volume density provides the likelihood that the predicted color value should be taken into account.

In some embodiments, an AI agent with a NeRF model 126 may generate output images 308 according to the instruction requesting generation of image data associated with the 3D model. In some embodiments, the output images 308 may be generated, from the NeRF model 126 and according to a requested view, two dimensional (2D) image data associated with the 3D model. In some embodiments, the 2D image data is generated with at least one portion of the 3D model in the requested view being obfuscated in the 2D image. The obfuscation of the portion of the 3D model may be a result of data inserted into the training to obfuscate sensitive details, or may be a result of parameters, such as resolution or instruction for handling small or high frequency model features that cause the NeRF model to interpolate or fill in details of a certain type of certain size during training when generating the NeRF model.

An image may be generated by calculating rays at each pixel or image subunit, and then coming the results to arrive at the output image 308. In some embodiments, an AI agent or NeRF model may use volumetric rendering, particle rendering, or the like. When generating output images, a ray is a function of its origin o, its direction d, and its samples at timesteps t. A ray at a timestep t is the sum of the origin and the product of the direction d and timestep t. The volume density and the color are dependent on the ray and to map the rays to an image, all the rays, in terms of the transmittance of a ray, the color and volume density are integrated over the bounds of the ray with respect to the timestep. The result is the color of a particular pixel. Determining the color of each pixel in an image results in an output image 308.

FIG. 3B is a symbolic diagram illustrating a system 320 for using an AI agent 322 with a NeRF model 126 according to some embodiments. The system 320, or each subsystem, such as the AI agent 322, display element, user display or prompt generation element 328, may be implemented on one or more computer systems, for example, using standalone computers, one or more servers, and/or cloud computing resources or systems. Thus, the system 320 or a subsystem may have one or more processors and one or more non-transitory computer readable memory or media, which may store computer program code for implementing functionality of the system.

References to computer-readable storage medium, computer program product, tangibly embodied computer program, or the like, or a controller, display system, computer, processor, or the like should be understood to encompass not only computers having different architectures such as single or multi-processor architectures and sequential (Von Neumann) or parallel architectures but also specialized circuits such as field-programmable gate arrays (FPGAs), application specific circuits (ASICs), signal processing devices and other devices. References to computer program, instructions, code, or the like, should be understood to encompass software for a programmable processor or firmware such as, for example, the programmable content of a hardware device whether instructions for a processor, or configuration settings for a fixed-function device, gate array or programmable logic device, or the like.

The system may have at least one processor and at least one memory, such as a non-transitory computer readable medium, and may include computer program code, that is configured to, with the at least one processor, provide the AI agent 322, MLP 124, and NeRF model 126, features. The memory may be a single component or, may be implemented as one or more separate components, some or all of which may be integrated or removable and may provide permanent, semi-permanent, dynamic, or cached storage.

The one or more processors are configured to read from and write to the at least one memory. The processor may also comprise an output interface via which data or commands are output by the processor and an input interface via which data or commands are input to the processor. The memory stores a computer program including computer program instructions that control the operation, when loaded into the processor, of the overall system 320, or one or more of the AI agent 322, MLP 124, NeRF model 126, display element 326, user display 330, or prompt generation element 328. The computer program instructions provide the logic and routines that enable the apparatus to perform the NeRF model 126 training, output image 324 generation, and display features and implement the AI agent 322 and NeRF model 126 system. The processor, by reading the memory, is able to load and execute the computer program. The computer program or programs may arrive at the apparatus via any suitable delivery mechanism. The delivery mechanism may be, for example, a computer-readable storage medium, a computer program product, a memory device, a record medium such as a compact disc read only memory (CD-ROM), digital versatile disc (DVD), portable memory such as a memory stick or hard drive, or the like, an article of manufacture that tangibly embodies the computer program. In some embodiments, the delivery mechanism may be a signal configured to reliably transfer the computer program over the air or via an electrical or optical connection.

The output images 324 may be provided to a display element 326 that prepares or handles the output images 234 for use by a user display 330, or for use in automated system such as video generation, or the like. For example, the NeRF 126 may output data, such as 2D images, a 3D mesh, an A/R or VR data structure, or the like. In some embodiments, the data output by the NeRF model 126 may be display ready, or may be images or other visual data that is ready for use by the display element 326 or user display 33. In other embodiments, the NeRF model 126 may output raw data or other data that is handled, modified, revised, combined with other data, or otherwise processed to generate output images 324 usable by the display element 326 or user display 330.

The display element 326, in some embodiments, is an element that collects output images 324 and provides those output images to a physical display such as a monitor, A/R display, VR headset, storage device, or the like. For example, the display element may be a server device that stores and transmits the output images 324 to a user display 330, and may, for example, provide an interface showing the output images 324 on the user display 330 so that the user may provide inputs for moving the view. The display element may receive those user inputs, and perform prompt generation, or have a prompt generation element 328, and provide a prompt for a new viewing angle or view of the 3D model that is provide to the AI for generation of new output images 324. In another example, the display element 326 may be video generation software that accumulated the output images, and transforms the output images from 2D still images into a 2D video by providing sequential still images in video format. The software may use a prompt generation element 328 to request the desired angles for generation of the 2D images using, for example, a preset, scripted set of images requested from the AI agent 322 by automated sequential or bulk prompt generation.

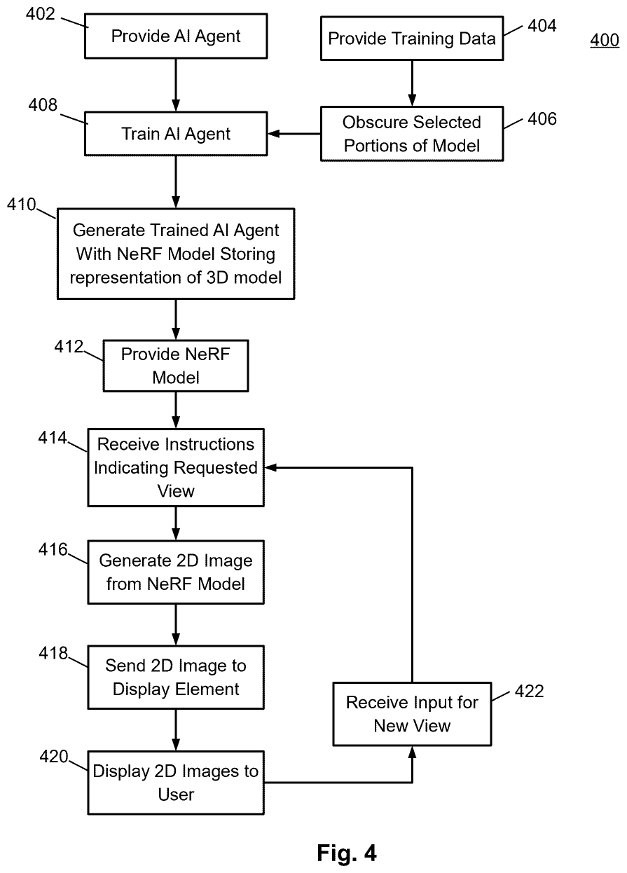

FIG. 4 is a flow diagram illustrating a method 400 for training and using an AI agent with a NeRF model according to some embodiments. In block 402, an AI agent may be provided. The provided AI agent may comprise a neural network configured to store a NeRF model, or may comprise a NeRF model. In some embodiments, the AI agent may be at least partially pretrained, and may have at least some training on features associated with NeRF model storage, image rendering based on the NeRF model, prompt interpretation, or the like. For example, an AI agent may be provided with training on generic rendering of NeRF mode, or with training on interpreting text prompts to accurately provide the requested views. In some embodiment, selection of the AI agent may be made based on past performance of a partially trained, or untrained, AI agent. For example, when selecting an AI agent for use in rendering a customized aircraft, a designer may select an AI agent that has high reliability or accuracy when rendering a similar aircraft model, or the same aircraft model with different customizations.

In block 408, the AI agent is trained. The AI Agent may be trained to store a representation of a 3D model in the NeRF model. In some embodiments, the AI agent is trained using the provided training data, and the training data may have one or more portions of the 3D model that are obscured or hidden by overlapping parts of the model. The AI agent may be trained to store a representation of the 3D model in the NeRF model, and may, in some embodiments, have at least one portion of the 3D model being obfuscated in the NeRF model, wherein the AI agent is configured to, after the training, generate, from the NeRF model and according to a first instruction indicating a requested view of the 3D model, two dimensional (2D) image data associated with the 3D model, wherein the 2D image data is generated with at least one portion of the 3D model in the requested view being obfuscated in the 2D image. Thus, in some embodiments, the NeRF model stores the representation of the 3D model with an inferred portion of the 3D model that was obscured during training. The NeRF model may be stored in a neural network having a different neuron of the neural network representing each voxel of the representation of the 3D model.

In some embodiments, obscuring the selected portions of the model or training the AI agent comprises generating second training data by adding obscuring data to first training data prior to training the AI agent, and training the AI agent using the second training data. The training the AI agent using the second training causes the NeRF model to store the representation of the 3D model with an inferred portion of the 3D model that was obscured during training. In other embodiments, obscuring selected portion of the model comprises adding, for example, structures or elements to the training data that covers selected portions of the training image. For example, for a helicopter, an image provider may wish to obscure a rotor head control system so that it is not viewable by, or at least not obvious to, a party receiving the data. In such an example, the image provider may black out the selected portion of the rotor head control system in the training data, and rely on inferences by the training of the NeRF model to, for example, fill in the missing portion of the images with a generic feature. In yet other embodiments, training of the AI agent may include the AI agent fuzzing, or replacing, selected portions of the training images or within the NeRF model itself. For example, where the image provider wishes to obscure the rotor head control system, an AI agent may be pre-trained to omit of overwrite the rotor head control system, or have setting or parameters indicating to overwrite, omit, or otherwise obscure the desired region of the model stored in the NeRF mode. The AI may replace the obscured portion of the 3D model in the NeRF model with an inferred portion or inferred features, may intentionally blur or fuzz the selected region or features, or may intentionally provide low-resolution features in the obscured portion of the NeRF model. The training data may be passed through the AI for application to the NeRF model.

The training results, in block 410 in a trained AI agent with a NeRF model storing, or having data associated with, a representation of the 3D model. Once the trained AI agent is available, the trained AI agent may be distributed so that, in block 412, and NeRF model is provided. The AI agent may, in block 414, receive instructions indicating a requested view of the 3D model or of the NeRF model. In some embodiments, the requested view is requested as a frame of a video, and multiple requests or instructions may be included in a single instruction, or multiple instructions may be sent to the AI agent to provide a series of video frames. In some embodiments, the instructions comprise data indicating a view location, view vector and a view frustum.

In block 416, the AI agent may generate a 2D image from the NeRF model. The 2D images may be representative of the 3D model and may be generated according to the requested view of the instructions, or according to a prompt, or other input. In some embodiments, the 2D image data is generated with at least one portion of the 3D model in the requested view being obfuscated in the 2D image. Additionally, in some embodiments, the 2D image may be generated using volumetric rendering, particle rendering, or another image generation technique. In block 418, the 2D image is sent to a display element, and may be sent on to a display device for display of the 2D image to a user in block 420. Thus, 2D image data may be sent to a display element for generation of a display for a user. In other embodiments, the display element may store the 2D mage or use the 2D image in generation of, for example, a video or the like. In block 422, a system, such as a display system, or the like, may receive input for a new view, and instructions may be generated for the new view, and passed to the AI system, which receives the new instructions, and repeats the generation of the 2D image using the new instructions.

An embodiment system includes one or more processors and at least one non-transitory computer readable memory connected to the one or more processors and including computer program code. The at least one non-transitory computer readable memory and the computer program code are configured, with the one or more processors, to cause the system to at least provide a neural radiance field (NeRF) model, store a representation of a three-dimensional (3D) model in the NeRF model, receive a first instruction indicating a requested view of the 3D model, and generate, from the NeRF model and according to the requested view, two dimensional (2D) image data associated with the 3D model, where the 2D image data is generated with at least one portion of the 3D model in the requested view being obfuscated in the 2D image.

In some embodiments, the NeRF model stores the representation of the 3D model with an inferred portion of the 3D model that was obscured during training. In some embodiments, the system of Claim 1, wherein the requested view is requested as a frame of a video. In some embodiments, the NeRF model is stored in a neural network having a different neuron of the neural network representing each voxel. In some embodiments, the at least one non-transitory computer readable memory and the computer program code are further configured, with the one or more processors, to cause the system to send the 2D image data to a display element for generation of a display for a user. In some embodiments, causing the system to generate the 2D image data includes causing the system to generate the 2D image data using volumetric rendering. In some embodiments, the first instruction comprises data indicating a view location, view vector and a view frustum.

An embodiment method includes providing a neural radiance field (NeRF) model, storing a representation of a three-dimensional (3D) model in the NeRF model, receiving a first instruction indicating a requested view of the 3D model, and generating, from the NeRF model and according to the requested view, two dimensional (2D) image data associated with the 3D model, wherein the 2D image data is generated with at least one portion of the 3D model in the requested view being obfuscated in the 2D image.

In some embodiments, the NeRF model stores the representation of the 3D model with an inferred portion of the 3D model that was obscured during training. In some embodiments, the requested view is requested as a frame of a video. In some embodiments, the NeRF model is stored in a neural network having a different neuron of the neural network representing each voxel of the representation of the 3D model. In some embodiments, the method further includes sending the 2D image data to a display element for generation of a display for a user. In some embodiments, generating the 2D image data includes generating the 2D image data using volumetric rendering. In some embodiments, the first instruction includes data indicating a view location, view vector and a view frustum.

An embodiment method includes providing an AI agent comprising a neural network configured to store a neural radiance field (NeRF) model, and training the AI agent to store a representation of a three-dimensional (3D) model in the NeRF model, where at least one portion of the 3D model being obfuscated in the NeRF model, where the AI agent is configured to, after the training, generate, from the NeRF model and according to a first instruction indicating a requested view of the 3D model, two dimensional (2D) image data associated with the 3D model, wherein the 2D image data is generated with at least one portion of the 3D model in the requested view being obfuscated in the 2D image.

In some embodiments, the training the AI agent includes generating second training data by adding obscuring data to first training data prior to training the AI agent, and training the AI agent using the second training data, where the training the AI agent using the second training causes the NeRF model to store the representation of the 3D model with an inferred portion of the 3D model that was obscured during training. In some embodiments, the requested view is requested as a frame of a video. In some embodiments, the NeRF model is stored in a neural network having a different neuron of the neural network representing each voxel of the representation of the 3D model. In some embodiments, the AI agent being configured to generate the 2D image data includes the AI agent being configured to generate the 2D image data using volumetric rendering. In some embodiments, the first instruction includes data indicating a view location, view vector and a view frustum.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. A system, comprising:
one or more processors; and
at least one non-transitory computer readable memory connected to the one or more processors and including computer program code, wherein the at least one non-transitory computer readable memory and the computer program code are configured, with the one or more processors, to cause the system to at least:
provide a neural radiance field (NeRF) model;
store a representation of a three-dimensional (3D) model in the NeRF model;
receive a first instruction indicating a requested view of the 3D model; and
generate, from the NeRF model and according to the requested view, two dimensional (2D) image data associated with the 3D model, wherein the 2D image data is generated with at least one portion of the 3D model in the requested view being obfuscated in the 2D image.

2. The system of claim 1, wherein the NeRF model stores the representation of the 3D model with an inferred portion of the 3D model that was obscured during training.

3. The system of claim 1, wherein the requested view is requested as a frame of a video.

4. The system of claim 1, wherein the NeRF model is stored in a neural network having a different neuron of the neural network representing each voxel.

5. The system of claim 1, wherein the at least one non-transitory computer readable memory and the computer program code are further configured, with the one or more processors, to cause the system to:
send the 2D image data to a display element for generation of a display for a user.

6. The system of claim 1, wherein causing the system to generate the 2D image data comprises causing the system to generate the 2D image data using volumetric rendering.

7. The system of claim 1, wherein the first instruction comprises data indicating a view location, view vector and a view frustum.

8. A method, comprising:
providing a neural radiance field (NeRF) model;
storing a representation of a three-dimensional (3D) model in the NeRF model;
receiving a first instruction indicating a requested view of the 3D model; and
generating, from the NeRF model and according to the requested view, two dimensional (2D) image data associated with the 3D model, wherein the 2D image data is generated with at least one portion of the 3D model in the requested view being obfuscated in the 2D image.

9. The method of claim 8, wherein the NeRF model stores the representation of the 3D model with an inferred portion of the 3D model that was obscured during training.

10. The method of claim 8, wherein the requested view is requested as a frame of a video.

11. The method of claim 8, wherein the NeRF model is stored in a neural network having a different neuron of the neural network representing each voxel of the representation of the 3D model.

12. The method of claim 8, further comprising sending the 2D image data to a display element for generation of a display for a user.

13. The method of claim 8, wherein the generating the 2D image data comprises generating the 2D image data using volumetric rendering.

14. The method of claim 8, wherein the first instruction comprises data indicating a view location, view vector and a view frustum.

15. A method, comprising:
providing an artificial intelligence (AI) agent comprising a neural network configured to store a neural radiance field (NeRF) model; and
training the AI agent to store a representation of a three-dimensional (3D) model in the NeRF model, wherein at least one portion of the 3D model being obfuscated in the NeRF model, wherein the AI agent is configured to, after the training, generate, from the NeRF model and according to a first instruction indicating a requested view of the 3D model, two dimensional (2D) image data associated with the 3D model, wherein the 2D image data is generated with at least one portion of the 3D model in the requested view being obfuscated in the 2D image.

16. The method of claim 15, wherein the training the AI agent comprises generating second training data by adding obscuring data to first training data prior to training the AI agent, and training the AI agent using the second training data, wherein the training the AI agent using the second training causes the NeRF model to store the representation of the 3D model with an inferred portion of the 3D model that was obscured during training.

17. The method of claim 15, wherein the requested view is requested as a frame of a video.

18. The method of claim 15, wherein the NeRF model is stored in a neural network having a different neuron of the neural network representing each voxel of the representation of the 3D model.

19. The method of claim 15, wherein the AI agent being configured to generate the 2D image data comprises the AI agent being configured to generate the 2D image data using volumetric rendering.

20. The method of claim 15, wherein the first instruction comprises data indicating a view location, view vector and a view frustum.
